(19) United States
(12) Patent Application Publication
(10) Pub. No.: US 2015/0262506 A1
(43) Pub. Date: Sep. 17, 2015

(54) LUNCHIN SYSTEM FOR RECORDING STUDENTS' MEAL SELECTIONS

(71) Applicant: John Vassallo, Reston, VA (US)

(72) Inventor: John Vassallo, Reston, VA (US)

(21) Appl. No.: 14/215,328

(22) Filed: Mar. 17, 2014

(51) Int. Cl. G09B 19/00; H04L 29/06; G09B 5/00

(52) U.S. Cl. CPC G09B 19/0092; G09B 5/00; H04L 63/08

(57) ABSTRACT

The present Lunchin system automatically monitors a student's food selections, identifies the quality of the choices that are made, and provides points for positive meal choices to allow access to specific rewards which further encourage a healthy lifestyle, with reports being available to the school and/or the student's parents. This system typically is implemented in a cafeteria environment, where a student is presented with a variety of food choices pursuant to a meal offering in a school environment. The student is identified prior to their making selections, the selections are tracked, and the relevant data about the content of the selections is compiled to create a record of the student's food choices as well as an analysis of the quality of these food choices. The system can include an alert functionality to advise the student when their selection violates a predetermined student-specific health factor that is stored in the system.

### FIELD OF THE INVENTION

This system relates to automatically monitoring a student's food intake, identifying the quality of the choices that are made, and optionally using gamification in the selection process to allow the student to acquire points for healthy choices, with reports being available to the school and the student's parents.

### Problem

It is a problem to provide students in school with nutritious meals, since healthy eating is critical for young children. The eating habits that are developed at a young age directly impact the health of these individuals as adults. In addition, poor eating habits are responsible for the appearance of a rising level of obesity in young children, and obese children are at a higher risk of heart disease, diabetes, stroke, and atherosclerosis. They are also twice as likely as their normal-weight peers to develop certain cancers and may be less likely to survive others. Obese children may have chromosomes that show signs of wear in the same ways as those of much older people. Their cells show inflammatory and oxidative damage that is usually the result of a much longer, often indulgent life. There is an intimate connection between obesity and the aging process, which begins in the cells within the fat tissue.

Therefore, it is imperative for students to develop and maintain healthy eating habits. To support this effort, gamification of healthy eating choices, which includes a reward system to enhance a healthier lifestyle, coupled with feedback to the parents and the school authorities, would assist in monitoring the student's food intake and to identify departures from a desired menu.

There are existing simple meal plan management systems, such as that disclosed in U.S. Pat. No. 5,969,316, which involves the use of smart cards configured with data indicating a specific meal plan for use in the food vending industry. An example is student meal plans purchased in college or other school systems where the user purchases a plan allowing the user to eat specific meals or at specific times. Usually, the meal plan is purchased at the beginning of the school term and terminates at the end of the school term. The meal plan management system uses a memory-based smart card that is preconfigured on a specific date and that contains data such as the meal plan type, the expiration date of the plan, the last transaction date, the user's weekly quota of meals, the number of meals a user can eat in a day, the user's daily quota, and the operator identification. Smart card readers are used to update data on the smart card and decrement existing data as the user purchases meals. However, this system fails to address the content of the meal choices or provide feedback to the student or the school authorities or the parents regarding the content of the meal choices.

Therefore, there is no system presently available that automatically monitors a student's food intake, identifies the quality of the choices that are made, and provides a reward system that furthers healthy eating, with reports being available to the school and the student's parents to assist in monitoring the student's food intake and to identify departures from a desired menu.

### Solution

The present Lunchin system automatically monitors an individual's food selections and identifies the quality of the choices that are made, with reports being available to characterize the quality of the meal selected and optionally provide a point system for the choices made. This system typically is implemented in a cafeteria environment, where a student is presented with a variety of food choices pursuant to a meal offering in a school environment. The student is identified prior to their making selections, the selections are tracked, and the relevant data about the content of the selections is compiled to create a record of the student's food choices and provide the correct point totals for the meal as well as an analysis of the quality of these food choices. The system can include an alert functionality to advise the student when their selection violates a predetermined student-specific health factor that is stored in the system or when the food selections provide them a very low point score for the meal. In addition, a record of the food selections optionally is made available to the school and the student's parents.

A numeric metric, based on a fixed scale, can be generated to indicate the quality of the food selection. In addition, reward points can be allocated to each meal choice to be the basis for tangible awards that can be offered to the students for the quality of the choices that they make. The awards can be funded by corporate sponsors or the school system and used to incentivize the student to make good choices. With appropriate safeguards, the data regarding the student and their food choices can also be made available to the student's physician, to provide real-time analysis of the student's dietary health.

### BRIEF DESCRIPTION OF THE DRAWINGS

FIG. 1 illustrates the Lunchin system as implemented in an exemplary environment, such as a school cafeteria; and

FIG. 2 illustrates in flow diagram form the operation of the Lunchin system.

### DETAILED DESCRIPTION OF THE INVENTION

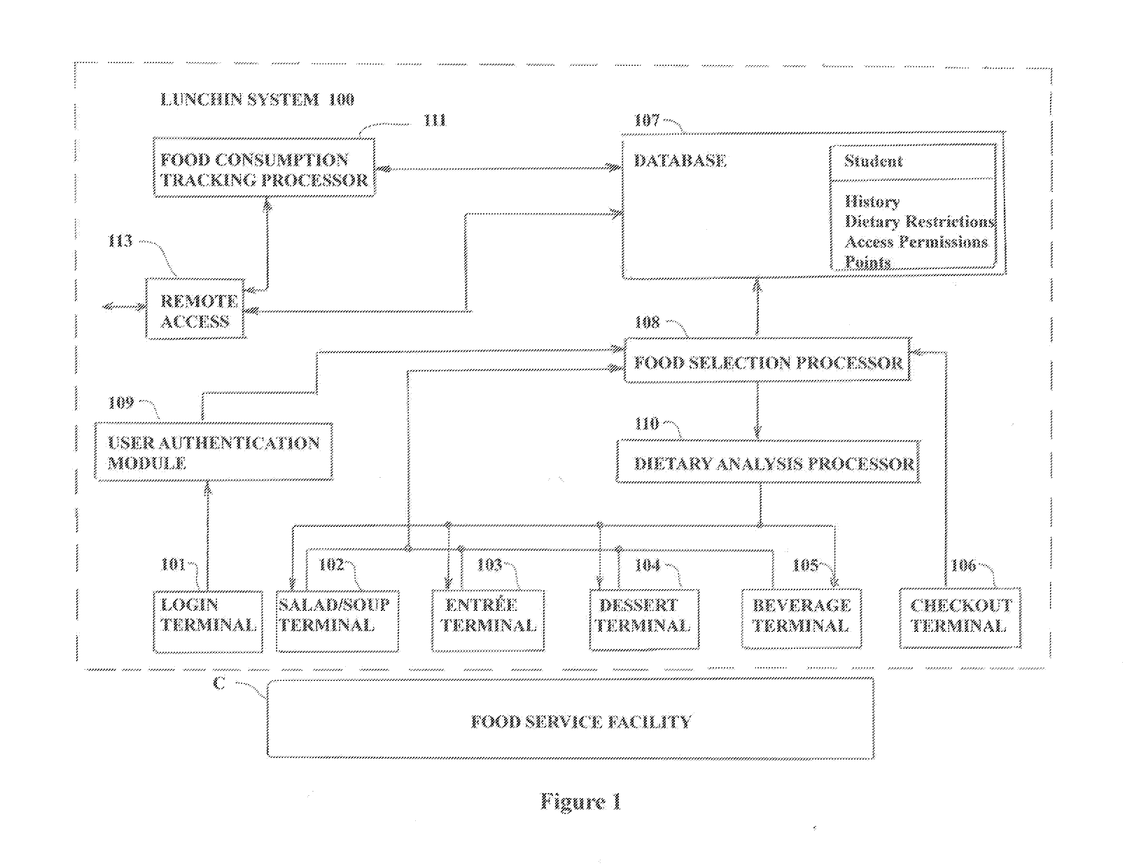

The Lunchin system 100 automatically monitors an individual's food intake at a food service facility and identifies the quality of the choices that are made, with reports being available to summarize the nature of the food selections made by the individual. The Lunchin system 100, as illustrated in block diagram form in FIG. 1, typically is implemented in a school cafeteria environment C (also termed “food service facility”), where a student (also termed “individual”) is presented with a variety of food choices, typically in a buffet presentation, pursuant to a predetermined set of meal offerings in a school, as is well known in the educational environment.

The Lunchin system 100 is architected not only to monitor the food choices made by the student, but also to provide feedback on a real-time basis to the student to teach them what food choices are appropriate. To assist in this effort, gamification can be used. Gamification is the use of game thinking and game mechanics in non-game contexts to engage users in solving problems or to improve user engagement. Gamification techniques strive to leverage people's natural desires for competition, achievement, status, self-expression, altruism, and closure. A core gamification strategy is to provide rewards for users who accomplish desired tasks, such as points, achievement badges, or providing the user with virtual currency or discounts on future purchases.

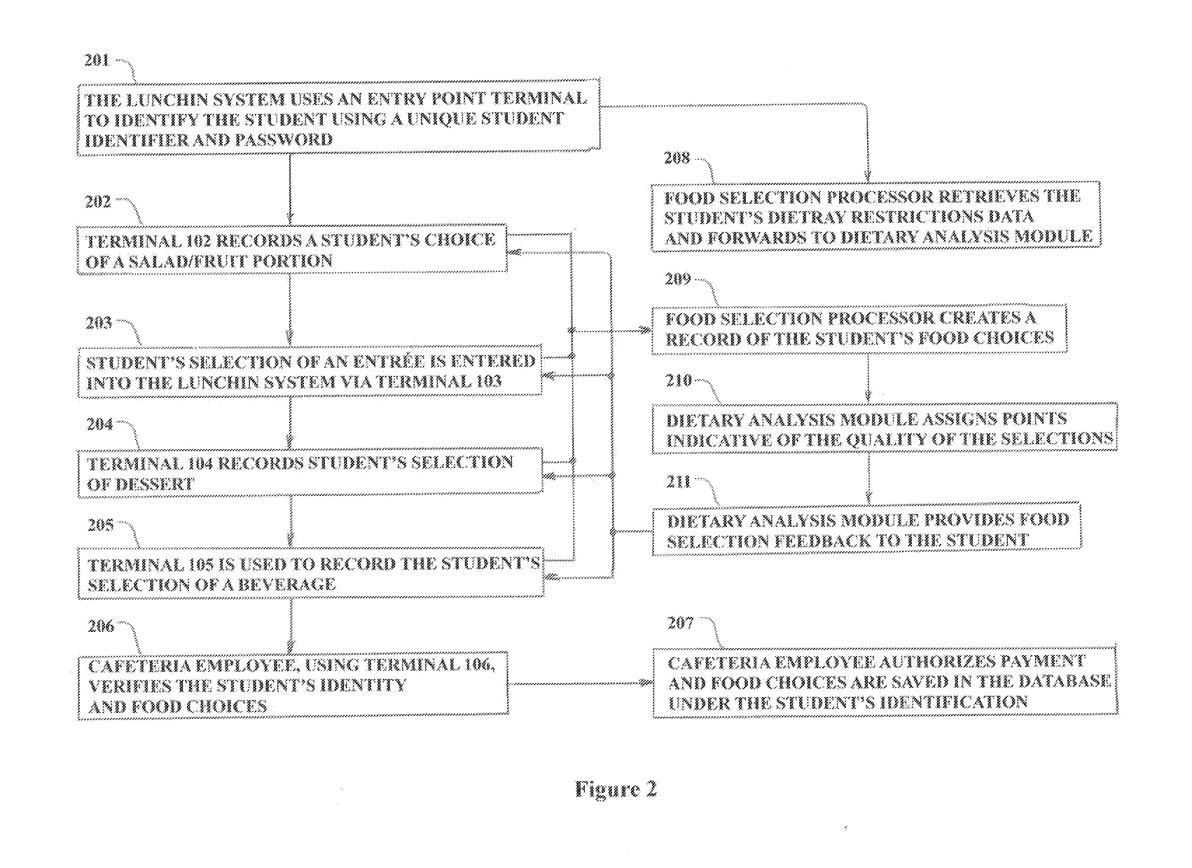

The Lunchin system 100 includes an entry point terminal 101 which at step 201 of FIG. 2 is used to identify the student via their account number, which typically is used to pay for their meal, prior to their making selections. The student identification can be via swiping an identification card that is in the possession of the student or the student logging into the Lunchin system 100 via entry point terminal 101, using a unique student identifier (account number) and password. Once the student is identified at step 201 by the user authentication module 109 comparing the data input by the student with a list of authorized students as stored in database 107, the Lunchin system 100 is enabled to receive data that identifies the food selections that are made by the student.

The food selection processor 108 at step 208 also prepares to analyze and record the food choices made by the student by accessing the database entries in database 107 that are associated with this student. These database entries can include a list of any dietary restrictions that are recorded for the student due to student-specific health factors. Typical student-specific health factors include, but are not limited to:
allergy alert—food selection contains allergens that may be harmful to the student;
gluten-free meal selection;
lactose intolerant’
diabetes;
religious dietary rules; and
caloric content of selection

These factors can be managed as a confidential data set which is stored into the database 107 in the Lunchin system 100 and updated by the student's physician and/or parents. The confidentiality of this data is maintained to ensure that the student's needs are not revealed to other students or school cafeteria staff An additional layer of functionality can be provided by a dietary analysis processor 110 which operates in conjunction with the meal selection functionality to advise the student when their food selection violates a predetermined student-specific health factor that is stored in the system. When the student selects a food item that is listed as not recommended in a dietary analysis processor 110, an alert can be sent to the student at step 211, as described below, for display on the terminal 104-106 at which the student is making a selection.

At one or more locations along the food service line in the cafeteria, terminals 102-106 are used to enter data into the Lunchin system 100. For example, at a first location at step 202, terminal 102 can be used to record a student's choice of a salad/fruit portion for their consumption. The recordation of the data can be via the student scanning a bar code on the selection or a cafeteria employee, who is co-located with the first food location, keying in the selection that the student makes, typically matching the student picture presented on the display of terminal 102 with an identification of the selection.

The data generated at terminal 102 to identify the student's food selection is used at step 209 by food selection processor 108 to create a record of the student's food choice in database 107. In addition, dietary analysis processor 110 assigns points to the student's food choice at step 210, which points are an indication of the quality of the selection. The assignment of points typically is done by the use of a food quality rule set which lists nutritional characteristics of food choices including, but not limited to: caloric value, carbohydrates, fat content, fiber content, etc. Since the food service provides a limited number of choices at each station, the dietary analysis processor 110 can compare the student's food choice with other food choices that are available. The food choice at a particular station also can be accumulated with the food choices made at other stations in the food service facility for this meal (or for the day). At step 211, the dietary analysis processor provides feedback to the student regarding their food selection and optionally recommending an alternative choice. The feedback can be visual and/or audible feedback, such as indicating the point total or violation of a student-specific health factor, and presented to the student on terminal 102.

As the student progresses down the cafeteria line, at step 203, the student's selection of an entrée is entered into the Lunchin system 100 via terminal 103 in a manner as described above with respect to the salad selection. The analysis and recordation of the student's entrée food selection is processed by steps 209-211 as described above. Additional stations are available to record other meal choices, such as a dessert selection station where, at step 204, the terminal 104 is used to record the student's selection of a dessert. The analysis and recordation of the student's dessert food selection is processed by steps 209-211 as described above. Another food selection station can be a beverage selection station where, at step 205, the terminal 105 is used to record the student's selection of a beverage. The analysis and recordation of the student's food selection is processed by steps 209-211 as described above. Finally, at step 206, a cafeteria employee, using terminal 106, verifies the student's identity and choices by reviewing the data presented on the screen of terminal 106 and comparing it to the food items on the student's cafeteria tray to finalize the record of the student's food selections and authorize payment at step 207, or the use of a credit/debit card, if payment is due.

In summary, as students choose their lunch meals, their choices are concurrently tallied by a food selection processor 108 at step 209 to create a record of the student's food choices, and points can be generated by food selection processor 108, which are indicative of the quality of the selections, at step 210. Furthermore, the students can receive real time feedback at step 211, which operates in conjunction to the recordation of the student's meal choices, via a display provided on the terminals 102-106. The displays can indicate the student's choice, points associated with the selection, and even suggestions for healthier choices. The accumulation of points can be used to reward the student for healthier choices.

The Lunchin app is developed for the personal use of the student and their parents and compiles data from user selected choices for points. Corporate sponsorship could be used to pay for the system and also can be used to sponsor rewards for good choices. The sponsors also can be the producers of various food choices. Graphics can be used to show the positive and negative benefits of the choices made.

Therefore, the Lunchin system 100 addresses the need to train the student to have good eating habits through gamification and can provide detailed feedback about the meal choices to third parties, such as the parents, family physician, and school authorities. The Lunchin system, therefore, provides a multi-function application, including: data collection, consumption tracking, and education provision for the students served by the cafeteria.

The feedback to the school authorities can be anonymized and used by food consumption tracking processor 111 to provide food offering tracking to enable the school cafeteria management to accurately identify popular food items, as well as the ability to correlate this information with specific cross-sections of the student population to identify combinations of foods that are popular. The data can be used by food consumption tracking processor 111 to calculate trends in food consumption, identify potential shortages of items that are scheduled to be used in future menus, generate reports that indicate average calories per meal delivered, number of meals served per day, etc. The usefulness of the food selection data extends far beyond simply tracking the food selections for a student; and once the food selection data is stored in the database, the uses of that data are considerable.

Access to the Lunchin system 100 from a remote location or other system is enabled by remote access module 113 which provides the well-known function of access control via the use of the login/password paradigm. The remote access can be used to enable the student's physician and/or parents to input dietary restrictions for the student into database 107, as regulated by the access permissions recorded in database 107. This remote access also can enable the parents and/or physician to access and review the stored food choice data and associated points. The points that are recorded in database 107 for the student can be redeemed for free food choices or can be used for the selection of a reward by the student from database 107 or another database which provides a selection of gift items.

What is claimed:

1. A tracking system for monitoring the food selections made by individuals who make use of a food service facility, comprising:
a login apparatus for collecting data provided by an individual to authenticate the identity of the individual;
a food identifier for generating data indicative of the food selections made by the individual;
a dietary analysis processor, responsive to the generated food selection data, for computing food quality data pursuant to a food quality rule set which is a measure of nutritional characteristics of the food selections; and
a database for storing the individual identification data and food quality data.

2. The tracking system of claim 1, further comprising:
a food selection processor for storing food selection data, indicative of the food selections made by the individual, in a database.

3. The tracking system of claim 1 wherein the food identifier comprises:
at least one terminal device for generating data indicative of the food selections made by the individual, each of the at least one terminal device being located substantially juxtaposed to the food items being selected.

4. The tracking system of claim 1 wherein the food quality rule set comprises:
a set of food characteristic data for each of the food selections to indicate a content of the food selection for each of a plurality of nutritional characteristics.

5. The tracking system of claim 1, further comprising:
food selection feedback for providing the individual with an indication of the food quality data computed by the dietary analysis processor.

6. The tracking system of claim 1, further comprising:
remote access for enabling an authorized third party to access the food selection data stored for the individual.

7. The tracking system of claim 1, further comprising:
a data anonymizer for blocking access to the individual identification.

8. The tracking system of claim 1, further comprising:
a dietary analysis processor for comparing the food selection with a set of individual-specific lists of dietary restrictions to automatically identify the selection of a food item that is inappropriate for the individual.

9. The tracking system of claim 8, further comprising:
food selection feedback for providing the individual with an indication of the food item that is inappropriate for the individual.

10. A method for monitoring the food selections made by individuals who make use of a food service facility, comprising:
collecting data provided by an individual to authenticate the identity of the individual;
generating data indicative of the food selections made by the individual;
computing in a dietary analysis processor, responsive to the generated food selection data, food quality data pursuant to a food quality rule set which is a measure of nutritional characteristics of the food selections; and
storing the individual identification data and food quality data in a database.

11. The method for monitoring the food selections made by individuals of claim 10, further comprising:
storing food selection data, indicative of the food selections made by the individual, in a database.

12. The method for monitoring the food selections made by individuals of claim 10 wherein the step of generating comprises:
operating at least one terminal device to generate data indicative of the food selections made by the individual, each of the at least one terminal device being located substantially juxtaposed to the food items being selected.

13. The method for monitoring the food selections made by individuals of claim 10 wherein the step of computing comprises:
storing a set of food characteristic data for each of the food selections to indicate a content of the food selection for each of a plurality of nutritional characteristics.

14. The method for monitoring the food selections made by individuals of claim 10, further comprising:
providing the individual with an indication of the food quality data computed by the dietary analysis processor.

15. The method for monitoring the food selections made by individuals of claim 10, further comprising:
enabling an authorized third party to access the food selection data stored for the individual.

16. The method for monitoring the food selections made by individuals of claim 10, further comprising:
blocking access to the individual identification stored in the database.

17. The method for monitoring the food selections made by individuals of claim 10, further comprising:
comparing the food selection with a set of individual-specific lists of dietary restrictions to automatically identify the selection of a food item that is inappropriate for the individual.

18. The method for monitoring the food selections made by individuals of claim 17, further comprising:
providing the individual with an indication of the food item that is inappropriate for the individual.
